(19) United States
(12) Patent Application Publication
(10) Pub. No.: US 2016/0298996 A1
(43) Pub. Date: Oct. 13, 2016

(54) DISCRETE CAPACITIVE FLOW STREAM HEIGHT MEASUREMENT FOR PARTIALLY FILLED PIPES

(71) Applicant: COVAR APPLIED TECHNOLOGIES, INC., McLean, VA (US)

(72) Inventors: Mark M. Koeroghlian, The Woodlands, TX (US); George Martin Milner, Round Rock, TX (US); Hendrik Gilmer, Fairfax, VA (US)

(73) Assignee: COVAR APPLIED TECHNOLOGIES, INC., McLean, VA (US)

(21) Appl. No.: 15/095,562

(22) Filed: Apr. 11, 2016

Related U.S. Application Data
(60) Provisional application No. 62/145,783, filed on Apr. 10, 2015.

(51) Int. Cl. G01F 23/26; G01F 1/66

(52) U.S. Cl. CPC G01F 23/268; G01F 1/663

(57) ABSTRACT

The invention relates to a system and method for measuring the flow stream height and velocity and other properties of water, drilling mud, or other liquid flowing through a pipe. The system comprises at least one and preferably a plurality of capacitive pads, connected to a data acquisition system capable of measuring the capacitance of each pad. These capacitive pads may be arranged radially around the inner diameter of a pipe or on a vertical probe inserted into the pipe. The pads that are submerged below the liquid level within the pipe will have a larger capacitance due to their proximity with a high dielectric fluid such as water or drilling mud. Conversely, the pads above the flow stream will have a lower capacitance due to their proximity to air. The fluid level can be inferred by determining the number of pads submerged in the fluid and by analysis of the capacitive values of pads nearest the fluid-air interface.

### CROSS REFERENCE TO RELATED APPLICATION

This application claims the benefit of U.S. Provisional Application Ser. No. 62/145,783 filed Apr. 10, 2015. Applicant incorporates by reference herein Application Ser. No. 62/145,783 in its entirety.

### FIELD OF THE INVENTION

The invention relates to systems and methods for sensing the amount and properties of drilling mud or any other liquid or flowing media with a dielectric constant different than air flowing through a pipe or channel.

### BACKGROUND AND SUMMARY

During the drilling process, drilling mud (actually a complex mixture of compounds) is usually pumped down the drill pipe and returns, carrying cuttings, up the annular region between the drill pipe and bore. The mud is typically routed away from the vertical well bore via a shallow angled pipe, e.g. 3 to 10 degrees from horizontal. The well bore could be either open hole or casing; however, at the top of the well, the bore will consist of steel casing. A representative flow path and pipe arrangement at the top of the well is depicted in FIG. 1.

When the mud pumps are shut-off (sometimes referred to as a “pumps off” event), flow rapidly decreases (shown in FIG. 2) and a corresponding drop in equivalent circulating density (“ECD”) can cause significant decreases in down hole pressures. Theses fluctuations in pressure are difficult to calculate precisely, and thus the well is vulnerable to transient influx (aka “a kick”) from the formation. Control during pumps off is also exacerbated by the difficulty in measuring flow accurately during the rapid transient decreases in flow. After flow-out has decreased to zero, influx may be indicated by a very small amount of flow (“trickle-flow”), which many flow sensing methodologies have difficulty measuring.

The ECD is the effective density exerted by a circulating fluid against the formation that takes into account the pressure drop in the annulus above the point being considered. The ECD is calculated as: d+P/0.052*D, where d is the mud weight in pounds per gallon (ppg), P is the pressure drop in the annulus between depth D and surface in pounds per square inch (psi), and D is the true vertical depth (feet). The ECD is an important parameter in avoiding kicks and losses, particularly in wells that have a narrow window between the fracture gradient and pore-pressure gradient.

Influx at pumps-off events typically manifests itself first as transient flow relative to an expected value near zero or as values rapidly converging to zero. Early influx detection is often dependent on detecting these initial small flow increments (or trickle-flow) at the return line since the corresponding pit volume increases can be significantly delayed, and thus changes in pit volume are usually detected only after significant influx has occurred. Accurate, reliable detection of trickle-flow may significantly improve influx detection at pumps-off.

A characteristic of the return line flow is often that the pipe is not full, rather, it is more like a trough flow. Mud from the well bore enters the return line and is accelerated by gravity until the force due to gravity is balanced by shear forces at the pipe wall. While the flow stream is accelerating, the fluid height continuously decreases and the average fluid velocity continuously increases until uniform flow conditions exit, at which point the height and velocity remain constant. The distance required for uniform flow to occur varies with flow rate and return line diameter; at high flow rates, it could be as much as 100 feet from the entrance. A typical velocity contour plot is shown in FIG. 3 (excerpted from Sandia National Labs report SAND91-2607, 1992), where lines of constant velocity are shown over the fluid cross-section for a pipe slope of 10° and a flow rate of 800 gpm. Steep velocity gradients can be observed near the pipe wall, while the vast majority of the flow cross-section is near the maximum speed. This is the conventional signature of turbulent flow and can exist down to 100 gpm or less. Accurately measuring flow in a partially-filled return line presents an additional challenge because the drilling mud is usually a non-Newtonian fluid.

The paddle meter (FIG. 4) is often used for measuring flow out on drilling rigs, both land-based and off-shore. A paddle is placed in the mud-flow and the deflection of the paddle is measured. Higher flow rates are indicated by a larger angular deflection of the paddle. A calibration function is applied to convert the angular deflection to flow-rate. This calibration function is often non-linear and may be a function of paddle geometry, assumed fluid viscosity, pipe diameter, and other factors. As can be seen in the graph below, there is significant scatter in the paddle meter output as a function of actual flow rate (FIG. 5, extracted from Sandia report, 1992). Independent research performed by Sandia National Labs reported ±15% accuracy for paddle meters.

Another method for obtaining flow rate in open channel flow systems is to measure the mean stream velocity and the flow stream height. If the channel geometry is known, then the flow area can be calculated based on the flow stream height, and if this is multiplied by the mean flow stream velocity, then volumetric flow rate can be calculated. Applying this methodology, the trickle flow rate resolution is governed by the resolution in flow stream height measurement and the resolution of the mean stream velocity measurement.

While this invention addresses a non-intrusive method to measure flow stream height in partially filled pipe flow, it could be combined with an existing means of measuring flow stream velocity to determine the bulk flow rate. For example, Doppler radar flow stream velocity measurements combined with ultrasonic flow stream height measurement has been used in other industries to determine the bulk stream velocity.

The method proposed herein utilizes the difference in dielectric properties of drilling mud (as compared to air) to detect the presence of mud by means of capacitance measurement. Most drilling fluids of interest have a dielectric constant between approximately 4 and 20, whereas air has a dielectric constant of 1. The sensor often comprises an array of capacitive pads formed radially around the inner diameter of a pipe with a data acquisition system (“DAQ”) which measures the capacitance of each pad. The dielectrically insulated, submerged pads will have a large capacitance due to their proximity with a high dielectric fluid. Conversely, the pads above the flow stream will have a lower capacitance due to their proximity to air. The liquid level can be measured by determining the number of pads submerged in the liquid, and measuring the response of the pads nearest the liquid-air interface. Additionally, the flow stream velocity (at some distance from the sensor pads) may be measured by comparing the temporal responses of capacitive pads in the downstream direction at equal relative heights with respect to the pipe wall.

The disclosed system and method are related to the drilling industry for example purposes only. Disclosed embodiments may be applicable for determining the type and amount of any flowing media that has a dielectric constant different than air flowing through a pipe, channel, or pipeline. The mining industry utilizes such flow conditions as does the water transportation industry.

### BRIEF DESCRIPTION OF THE DRAWINGS

FIG. 1 depicts a mud flow path and pipe arrangement at the top of the well bore.

FIG. 2 depicts a typical flow out characteristic curves when mud pumps are shut off. Time along x-axis is in seconds. Volume flow rate is along y-axis.

FIG. 3 depicts the velocity contours for 800 gpm drilling mud flow in a 10° return line.

FIG. 4 depicts a paddle style mud flow meter.

FIG. 5 depicts a graph of the flow rate calibration of a paddle meter.

FIG. 6 depicts an example schematic for a capacitive sensor.

FIG. 7 depicts the simulated output from a capacitive sensor.

FIG. 8 depicts a graph of capacitive measurement sensitivity, Distance (mm) v. Clock Cycles.

FIG. 9 depicts a graph showing capacitive measurements for a variety of fluid types.

FIG. 10 depicts a sensor cartridge concept with a spanner nut.

FIG. 11 depicts pad spacing on the interior wall of a pipe.

FIG. 12 depicts a discrete capacitive pipe wall configuration with three sensor arrays.

FIG. 13 depicts a discrete capacitive sensor in the vertical probe configuration.

FIG. 14 depicts a basic capacitive pad.

FIG. 15 depicts an interdigital finger to increase capacitance and sensitivity as compared to straight pads.

FIG. 16 depicts capacitive pads array wrapped in circular ring on inside of pipe.

FIG. 17 depicts two capacitive pad arrays wrapped around inside diameter of pipe, offset angularly from each other to increase resolution.

FIG. 18 shows the radial orientation of capacitive pads is somewhat inconsequential as any pad pair can serve as the “bottom” of the pipe. The bottom pad pair can be determined by the sensor system.

FIG. 19 depicts multiple capacitive pads arrays.

FIG. 20 depicts a closer view of multiple capacitive pad arrays.

FIG. 21 depicts a possible change to the angle of the boards relative to flow direction in order to increase the resolution.

FIG. 22 depicts a graph of the flow stream height as a function of radial distance measured in capacitive pads.

FIG. 23 depicts a graph of the change in fluid height per capacitive pad as a function of radial distance (measured in pad width) for several pipe diameters.

FIG. 24 depicts a graph of the change in flow rate (gpm) per pad as a function of flow rate. As the flow rate increases (from trickle flow to ½ full pipe), the sensitivity to change in flow rate decreases.

FIG. 25 depicts multiple examples of Doppler radar field-of-view for different in-pipe fluid levels.

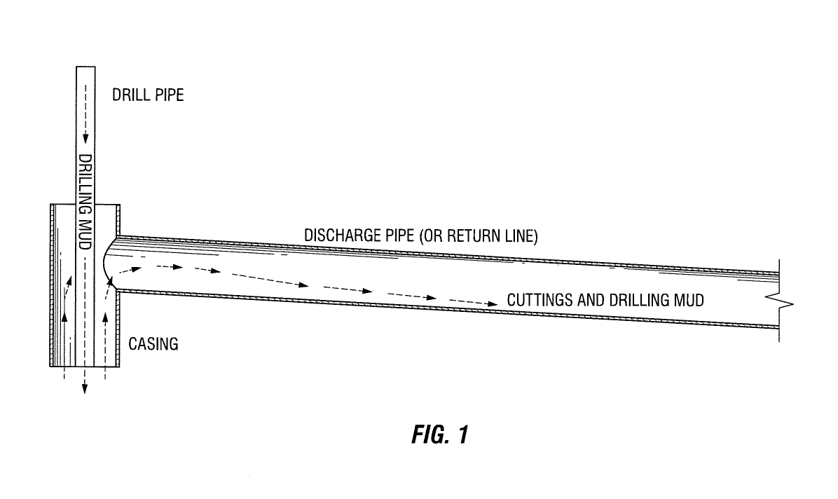

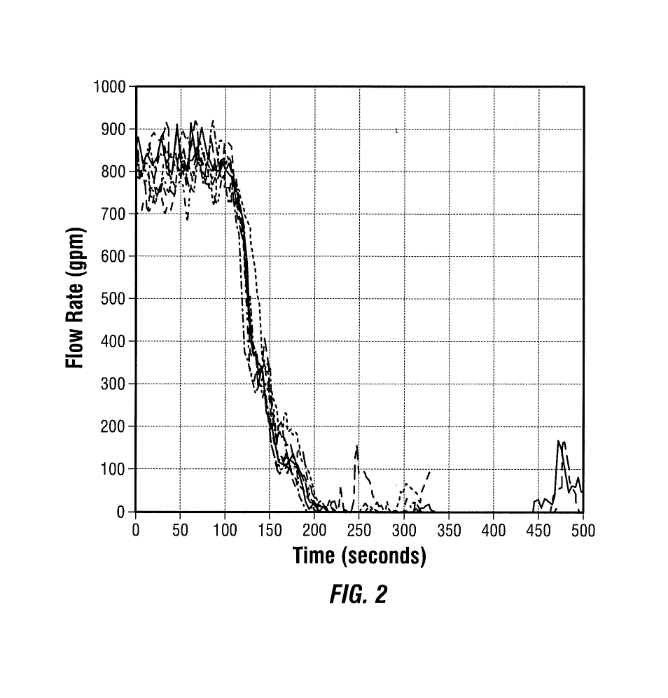

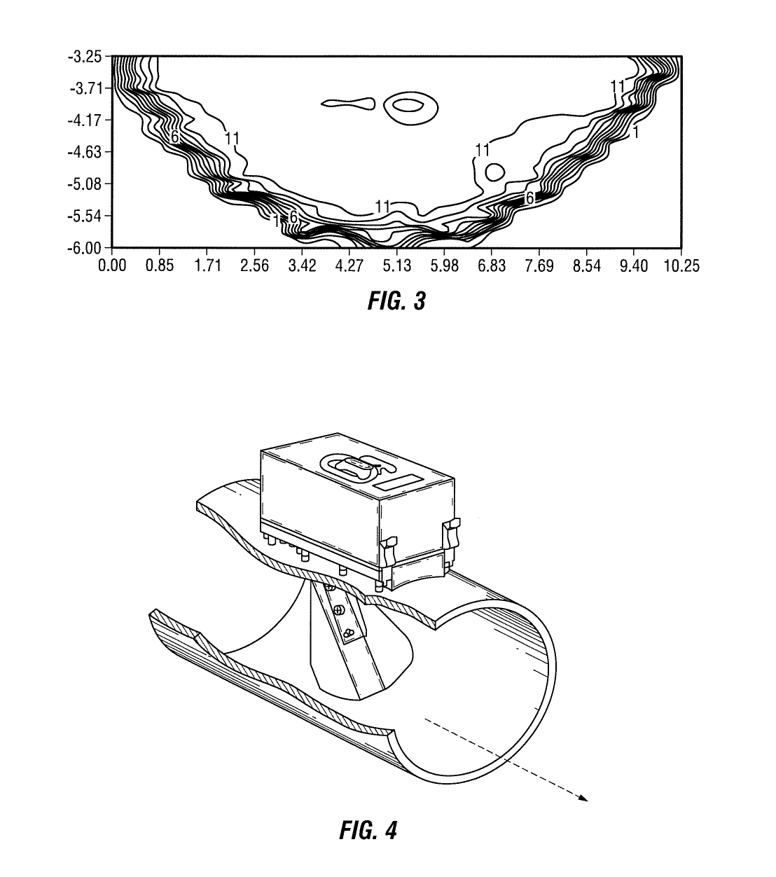

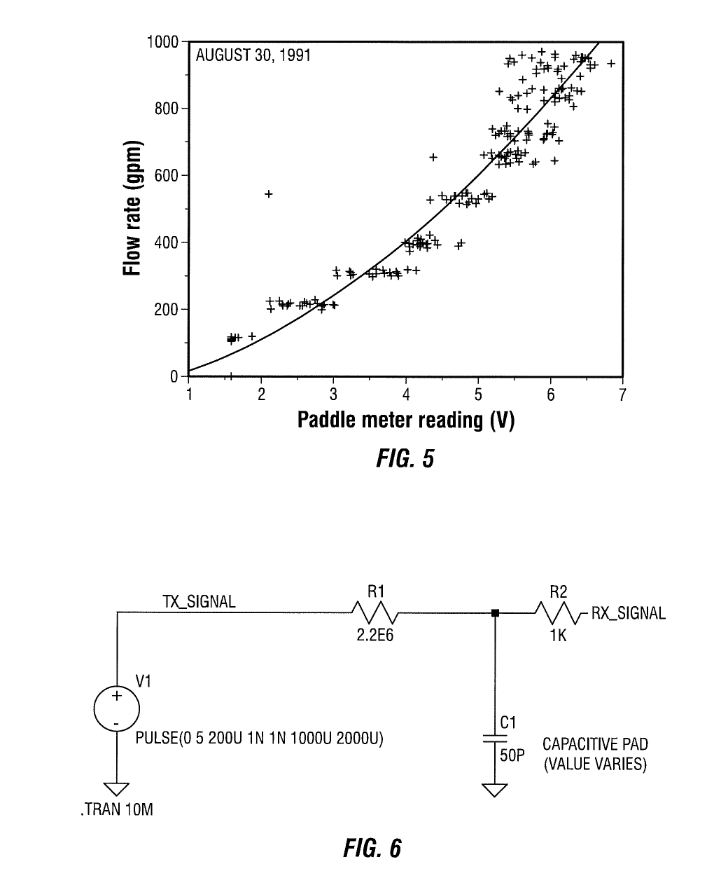

### DETAILED DESCRIPTION

To understand how discrete capacitive sensing can be used to measure flow rate, the general principle is described. The basic equation for a parallel plate capacitor is:

$$C = ɛ \frac{A}{d}$$

In this equation, ε is the dielectric constant (or relative permittivity) of the material between the pads, A is the shared area of the capacitive pads, and d is the distance between pads. As can be seen, a capacitor's value can be changed by changing the dielectric between the two plates.

In most capacitive sensing configurations, there are not parallel pads and the equation is more complex. However, capacitance is still proportional to pad area and the dielectric properties of the material adjacent to the pad. Hence a pad adjacent to water and oil-based fluids has a much higher capacitance than an equivalent pad adjacent to air, due to water and oil-based fluids having a much higher dielectric constant than air.

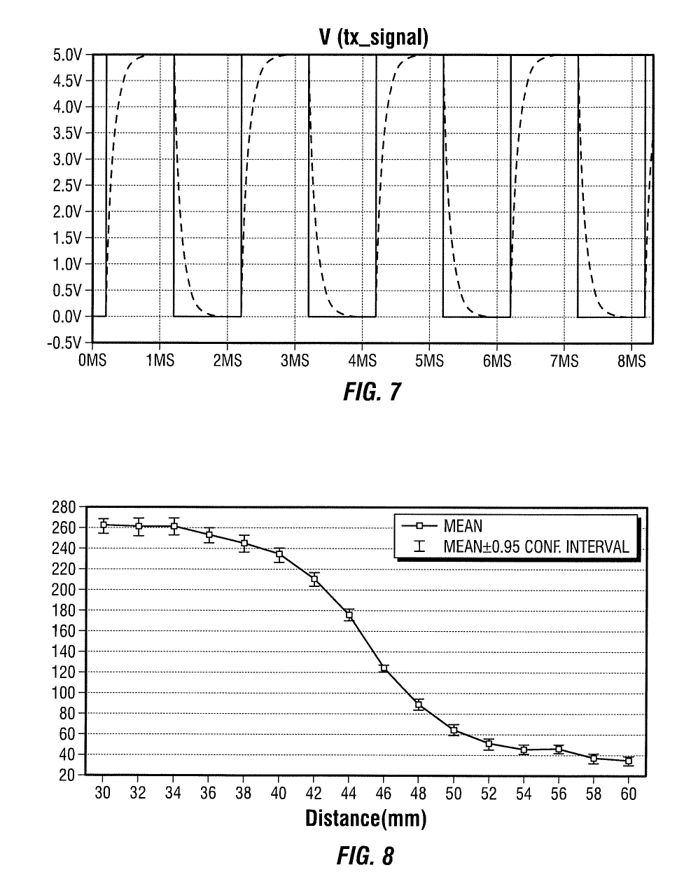

Capacitive sensors typically consist of one or multiple pads adjacent to the environment being sensed, and an electronic circuit that measures the capacitance of those pads. An example of such an electronic circuit is shown in FIG. 6. In this example, C₁ is the capacitive pad with a nominal capacitance of 50 pico-Farads. The pad is connected to voltage source V_{I} through a large series resistor. V₁ transmits a square wave with a 50% duty cycle and an ON time of 1000 msec. A receiver is connected to the pad via a much smaller series resistor. At the receiver, a delayed version of the square wave is seen. This can be seen in FIG. 7, the simulated output of the circuit in FIG. 6. The delay between the transmitted (green) and received (blue) waveforms is a function of the series resistance R1 and the pad capacitance value, C₁. If C₁ changes due to the presence of water or drilling mud near the pad, the received waveform delay will increase relative to the transmitted waveform.

Discrete capacitive flow stream height sensors are based on the principle described above. Large numbers of long, narrow capacitive pads are placed at the perimeter of the flow stream, or possibly in the flow stream. To determine flow height, a data acquisition system compares the delay value of each capacitive pad to a threshold to determine whether that pad is above or below the surface of the fluid. Then, an algorithm calculates the fluid level based on the number of submerged pads, the known pad and pipe geometry, and the relative measured capacitance of the pads nearest the liquid-air interface.

Based on initial test results, it appears that this method could yield an overall height measurement resolution of less than 2 mm and a trickle flow height resolution of less than 1 mm. This is illustrated in FIG. 8 where the sensor capacitive response is plotted against a reference distance from a fluid sample to a capacitive pad.

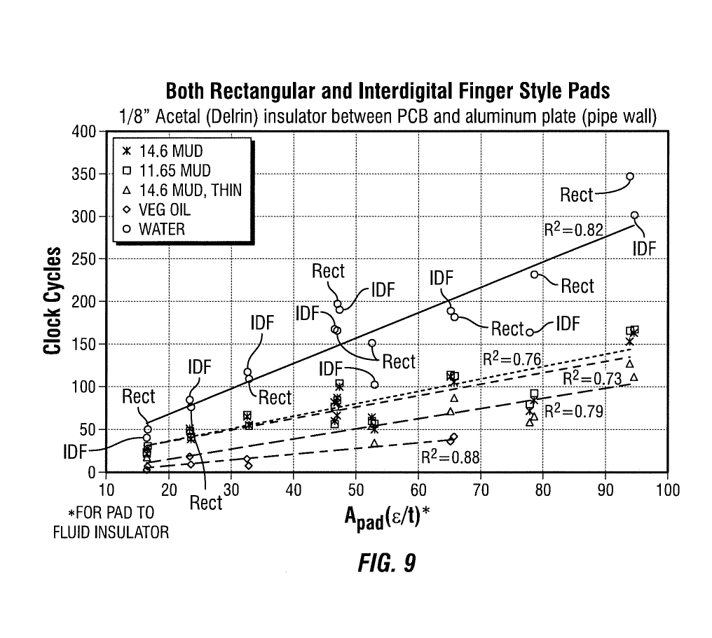

Initial results also suggest that it is possible to distinguish between oil-based muds (“OBMs”) and water-based muds (“WBMs”). This is shown in FIG. 9, where sensor response (in clock cycles) is plotted against effective capacitance for various combinations of capacitive pad areas/shapes, dielectric insulation material thicknesses, and fluids. Given that this technique is very sensitive to different fluid samples and the specific fluid properties, it may also be possible to determine if there is gas entrained in the mud stream based on measurements from the capacitive pads.

The sensor hardware is compatible with existing mud return line construction. It is robust to the operational environment and substantially insensitive to temperature as well as gas composition in the head-space above the mud flow stream.

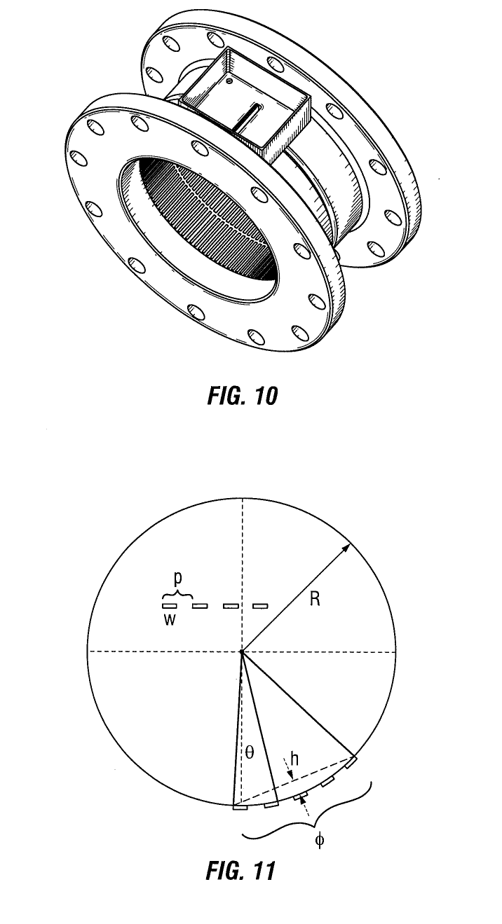

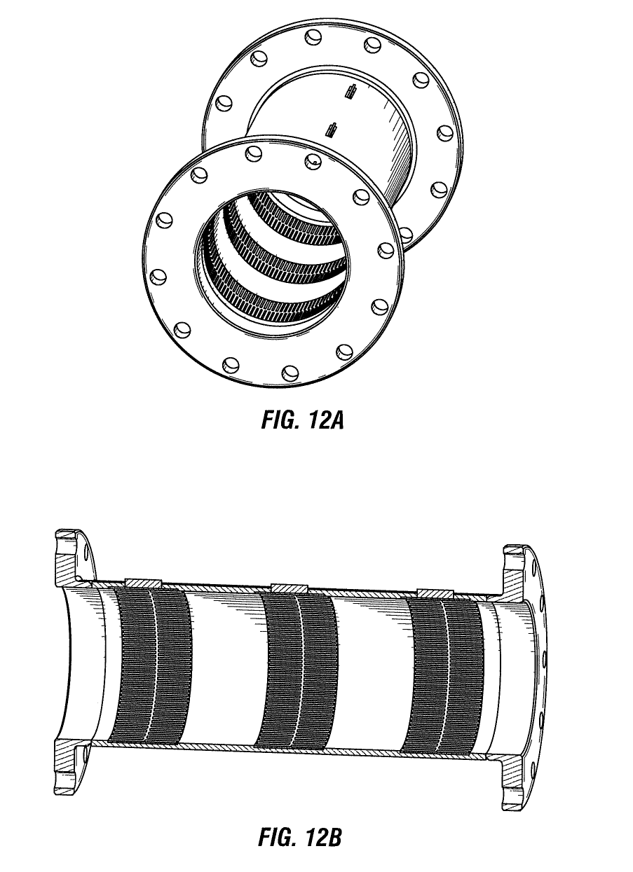

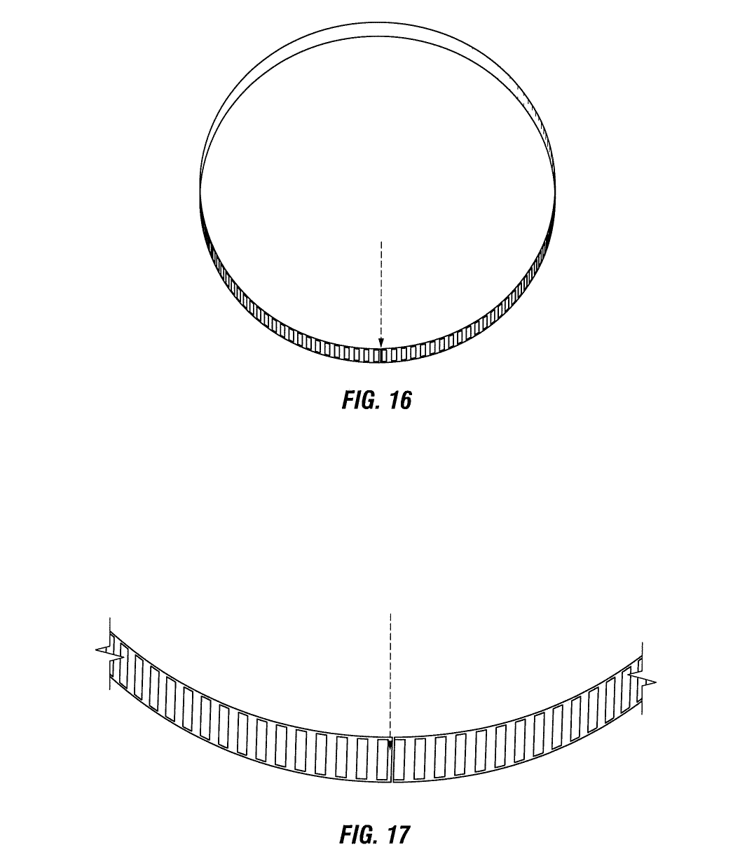

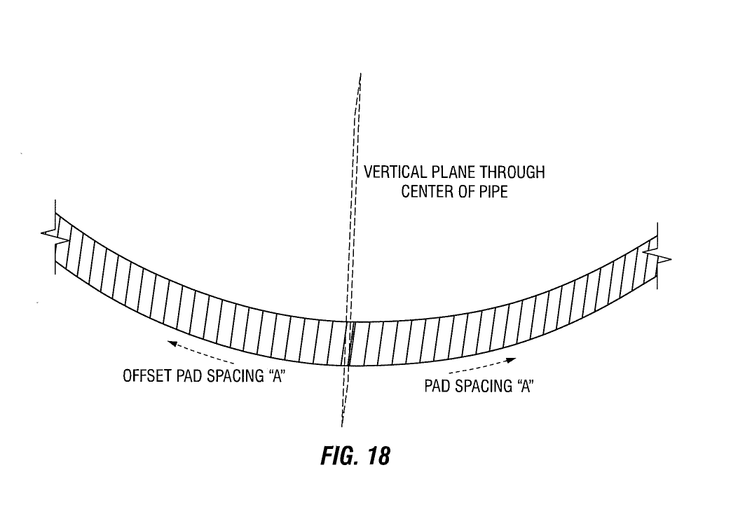

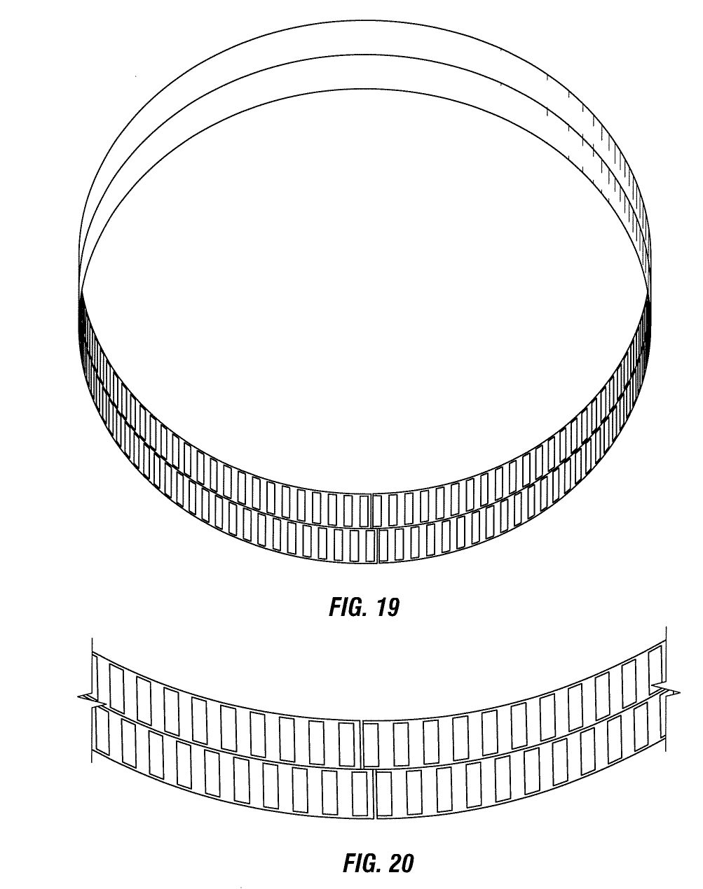

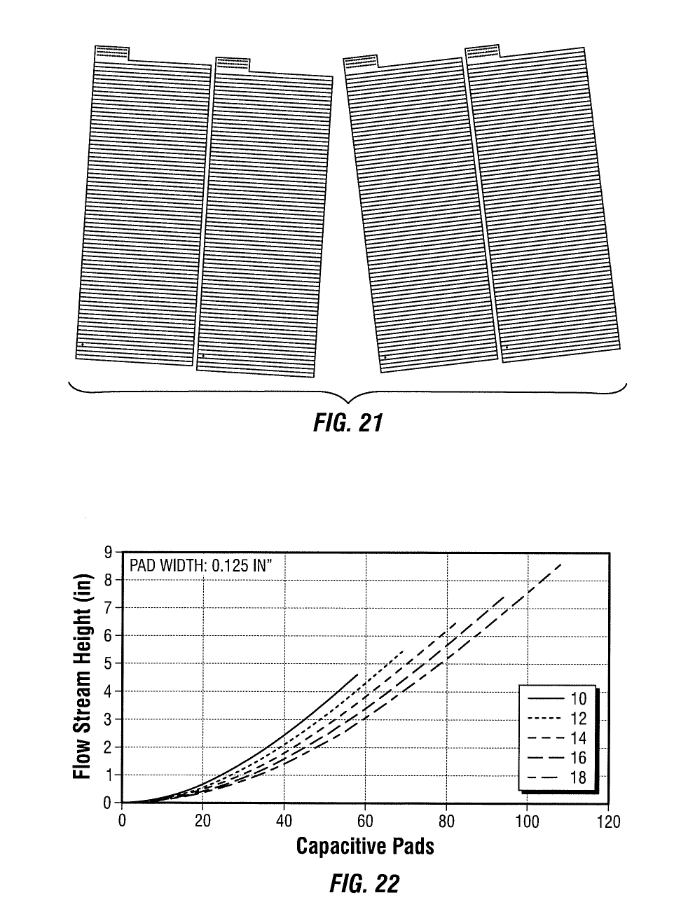

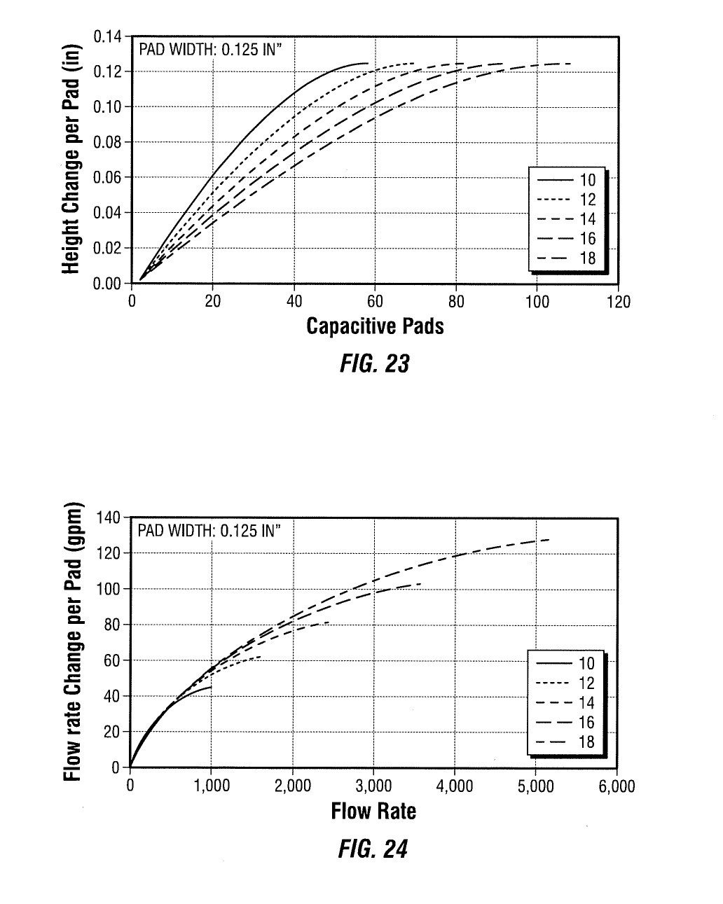

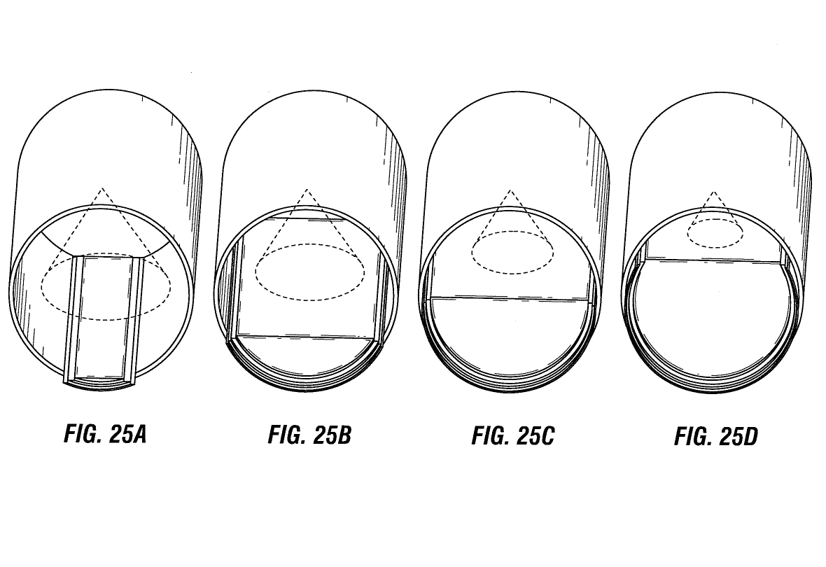

There are multiple potential embodiments for a discrete capacitive sensor. In one embodiment, a single sensor “element” comprised of one or more flexible or rigid circuit boards containing arrays of capacitive pads line a steel pipe wall (depicted in FIGS. 10 and 16). A multi-sensor version of this ‘pipe-wall’ configuration is envisioned where the sensor elements are spaced some distance apart to provide redundant sensing. Multiple sensors separated by axial distance has an additional benefit of potentially detecting standing waves in the flow stream. A 3-element sensor version is shown in shown in FIG. 12.

Based on initial experiments, the pad width (w) is 0.125″ and the spacing (or pitch, p) is twice the pad width (p=2w) as shown in FIG. 11. The arc angle (θ) of the pad (including the space between pads) is a function of the pipe radius (R), such that p=Rθ where θ is the included angle of pad-space pair. There are 2π radians in the circumference of a circle. The number of capacitive pad elements (n) within the circumference of the circular cross-section is 2π/θ. Substituting 2w/R for θ yields n=2πR/(2w) which simplifies to πR/w. In reality, there may be fewer than “n” pads for any given pipe diameter because some pads at the top of the pipe may be missing to allow for connections to the electronics. This should not usually pose a problem because the flow rate when the pipe is full or nearly full is not particularly critical and the incremental flow not accounted for by the last few missing pads becomes less significant as the pipe approaches “full”. If it is not negligible, then adjustment to the calculations may be useful. Some embodiments of the disclosed system may utilize an alternate pad geometry optimized to provide a higher signal to noise ratio under certain conditions. Alternate geometries may also be configured to minimize sensor size.

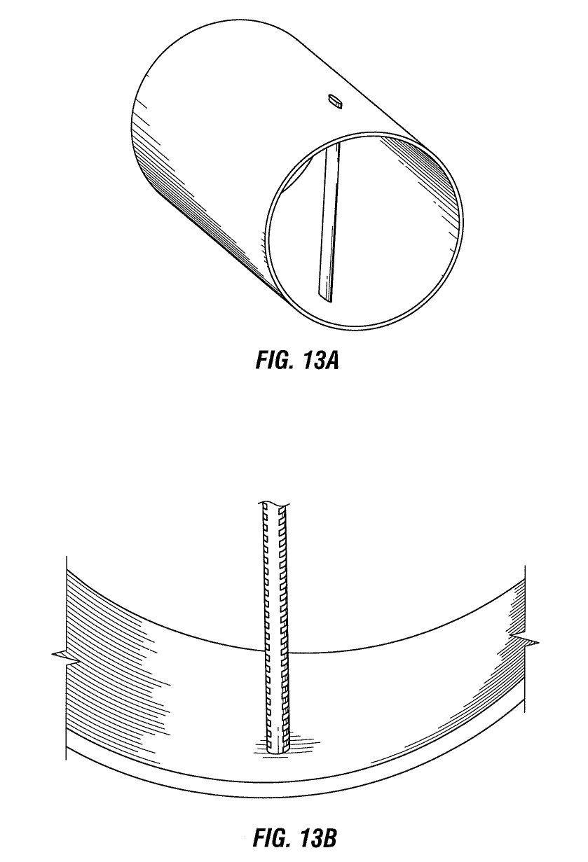

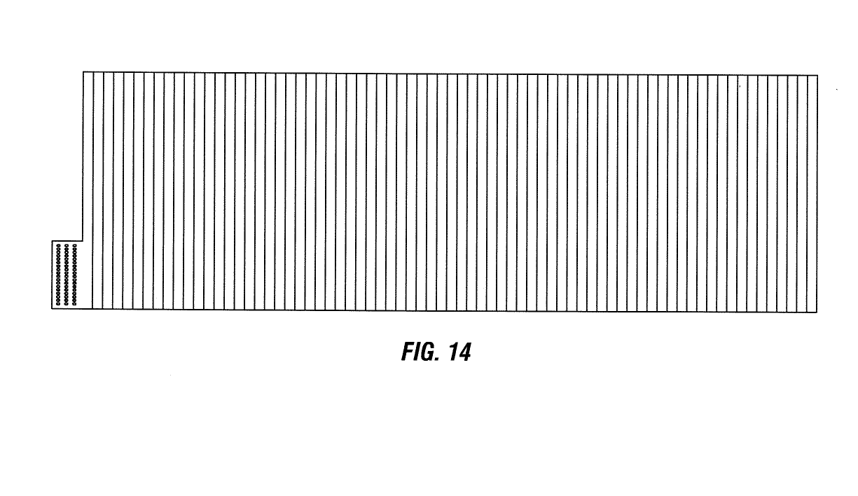

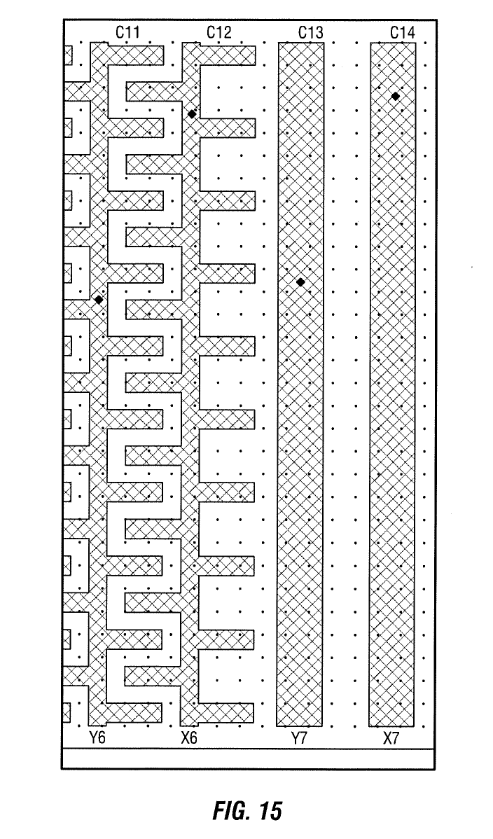

In an alternate discrete capacitive embodiment, a thin vertical probe containing an array of capacitive pads on both sides may be inserted through the center of the pipe into the flow-stream. This approach has the advantage of a simplified installation. An example of a single-channel ‘vertical probe’ configuration is shown in FIG. 13. This embodiment may be used to determine the height of a fluid flowing through a pipe.

Additionally, a sensor module or processor may be configured to calculate the height of the fluid above a calculated “ground” plane. This will allow the system to control the distance from the capacitive pads to the apparent pipe wall independent of the position of the actual pipe wall.

Dynamic Sampling for Increased Height Resolution

There are many sampling options for the system. Time Division Multiplexing is one possible approach to measure capacitance from all capacitive pads. Specifically, the data acquisition system will measure the value of one pad at a time, starting at the bottom of the pipe. This sampling method may result in a lower frame rate than might otherwise be desirable. There are several methods of sampling that can potentially increase the frame rate significantly.

Several dynamic sampling methods are available. The first method is to sample from several pads simultaneously. This method has the potential to increase the sample rate by several orders of magnitude. Ideally, it would be possible to sample from one pad of all N sampling chips simultaneously, thereby increasing frame rate by a factor of N. One should consider the bandwidth of the communication link, and the potential for electro-magnetic interference from simultaneous sampling of pads in close proximity.

Another dynamic sampling method is to increase sampling of pads close to the fluid level, and decrease the sampling of pads well below or well above the fluid level. This method also has the potential to increase frame-rate significantly because there are a low number of pads at the fluid level relative to those well below or above the fluid level. Feedback from the fluid height algorithm may be useful for this method.

Multiple Pad Sampling for Increased Depth Penetration

The measurement range of a capacitive pad can often be increased by increasing the area of the pad. The significance of high-range measurements in mud flow sensing is the ability to detect sediment buildup on the bottom of the pipe, and the ability to detect the presence of fluid beyond the sediment buildup. One method useful in capacitive sensing to increase pad size is to simultaneously activate multiple adjacent pads and use them in a similar manner as one large capacitive pad.

Sediment Build-up Identification

Sediments are known to build up in the mud return lines. A discrete capacitive sensor should be able to detect this sedimentation build-up. As sediments build up above the capacitive pads, they can eventually create a constant dielectric “field” and the capacitance measured in the pads will remain relatively constant. Conversely, the dielectric properties of a flowing mud stream are expected to vary with changes in the fluid dielectric. It may be useful to differentiate these different behaviors and modify the pipe geometry to provide a more accurate flow stream height estimate (or perhaps a flow area estimate). Additionally, the sensor could alert the operator that sediments are detected with the return line.

Entrained Gas Detection

Gas entrained in the mud flow stream can change the fluid dielectric properties. Because the sensors measure the capacitance of the fluid in close proximity, it is conceivable that the proposed sensor system may be able to detect the change in dielectric properties of the mud (drilling fluid) as gas is introduced into the flow stream

Fluid Velocity Measurements

Fluid velocity is essential to conversion of fluid height to fluid volume flow rate. One method of measuring fluid velocity is the Doppler radar technique described previously. Another possible method would use the capacitive pads in series in an axial configuration so that the waveforms of capacitive value versus time due to inhomogeneous fluid properties will be delayed by a known distance for the fluid flow. The delay can be estimated through cross correlation techniques and the measured delay can be converted to an estimated fluid flow rate.

Doppler Radar in Combination with the Discrete Capacitive Flow Stream Height Sensor

Doppler radar flow stream velocity measurements combined with ultrasonic flow stream height measurement may be used to determine the bulk stream velocity. The surface of the fluid measured by a Doppler radar system can be thought of as a circular or elliptical area, where the size of the ellipse is a function of the sensor height, sensor angle, and the directionality of the antenna. FIG. 25 shows this concept graphically for several in-pipe fluid levels. As shown in previous sections, different regions of the flow stream have different velocities. Therefore, if Doppler radar illuminates a large surface of the flow stream, there should be multiple velocities at its receiver.

Most commercial Doppler radar systems digitize the received signal and after processing, only provide the user with a single velocity measurement. In this case, it may be desirable to receive the raw Doppler velocity spectrum at the receiver, and use this for a more accurate velocity calculation.

One drawback to using the above approach with a single Doppler radar is that as flow height increases, the area illuminated by the sensor decreases, and the velocity profile may be reduced to, e.g. a single velocity measurement at the center of the channel. One potential method to overcome this is by adding one or multiple axially offset sensors to measure surface fluid velocity profile.

At trickle flow, the field-of-view is wider than the fluid channel and the velocity reading will include some areas with zero velocity. At low to medium fluid levels, the field-of-view will include a large portion of the flow cross section and it may be possible to measure an accurate fluid surface velocity profile.

Disclosed embodiments relate to a system for measuring the flow stream height of a liquid flowing through a pipe. Embodiments of the system comprise a plurality of capacitive pads, said capacitive pads arranged within a pipe, a data acquisition system connected to said pads wherein said data acquisition system is capable of measuring the capacitance of each pad, and a processor capable of calculating the flow stream height based on the capacitance of each pad.

In some embodiments the capacitive pads are protected from abrasion and corrosion using a film or polymer coating. Embodiments may also be configured to optimize the signal to noise ratio by adjusting the pad geometry based on the application.

Preferred embodiments disclosed include:

(1) A system for measuring the flow stream height of a liquid flowing through a pipe comprising:
a plurality of capacitive pads, said capacitive pads arranged within a pipe;
a data acquisition system connected to said pads wherein said data acquisition
system is capable of measuring the capacitance of each pad; and
a processor capable of calculating the flow stream height based on the capacitance of each pad.
(2) The system of embodiment 1 wherein the capacitive pads are arranged radially within the interior of a pipe.

(3) The system of embodiment 1, wherein the capacitive pads are protected from abrasion and corrosion.

(4) The system of embodiment 1, wherein the capacitive pad geometry is optimized to maximize the signal to noise ratio.

(5) The system of embodiment 1, wherein the capacitive pad geometry is optimized to maximize the signal to noise ratio while minimizing sensor size.

(6) The system of embodiment 1, wherein the position of an apparent ground plane is calculated by the processor.

(7) The system of embodiment 1 wherein multiple capacitive pads are axially displaced along the pipe.

(8) The system of embodiment 1 wherein multiple capacitive pads are arranged in an array.

(9) The system of embodiment 8 wherein a plurality of arrays are angularly offset from each other.

(10) The system of embodiment 1 wherein the capacitive pads are interdigital finger pads.

(11) The system of embodiment 1 wherein time division multiplexing is used to measure the capacitance of the capacitive pads.

(12) The system of embodiment 1 wherein a dynamic sampling method is used to measure the capacitance of the capacitive pads.

(13) The system of embodiment 12 wherein the capacitance of multiple capacitive pads is measured simultaneously.

(14) The system of embodiment 13 wherein the capacitance of multiple adjacent capacitive pads is measured simultaneously.

(15) The system of embodiment 12 wherein the capacitance of the capacitive pads proximate to a liquid gas interface is measured more frequently than the capacitance of the capacitive pads further from said interface.

(16) The system of embodiment 1 wherein the capacitive pads are arranged on a vertical probe.

(17) A method for measuring the flow stream height of a liquid within a pipe comprising:
measuring the capacitance of a plurality of capacitive pads,
calculating the height of a flow stream based on the measured capacitance of the capacitive pads.

(18) The method of embodiment 17 further comprising measuring the capacitance of a plurality of capacitive pads axially displaced from one another.

(19) The method of embodiment 17 further comprising using a previously calculated flow stream height to optimize subsequent measuring of the capacitance from a plurality of capacitive pads.

(20) The method of embodiment 17 wherein the capacitance of multiple capacitive pads is measured simultaneously.

(21) The method of embodiment 17 further comprising calculating the presence of a gas entrained in a liquid stream based on the measured capacitance.

(22) The method of embodiment 21 wherein the liquid is a drilling fluid.

(23) A method for measuring the velocity of a liquid flow stream comprising:
using a Doppler radar system to illuminate the surface of a liquid flow stream,
receiving a Doppler radar signal, and
calculating the velocity of the flow stream based on the received Doppler radar signal.

(24) The method of embodiment 23 wherein multiple axially offset sensors are used to measure the velocity of the liquid flow stream.

(25) The method of embodiment 23 further comprising using an ultrasonic flow stream height measurement to calculate the height or velocity of the flow stream

(26) A method for calculating the flow stream velocity of a liquid within a pipe comprising:
measuring the capacitance waveforms of a first set of capacitive pads,
measuring the capacitance waveforms of a second set of capacitive pads,
   said second set of capacitive pads being axially displaced a known distance from the first set,
comparing the capacitance waveforms of the first set of capacitive pads with the capacitance waveforms of the second set of capacitive pads,
calculating the velocity of the flow stream based on the relationship of the capacitance waveforms of the first set and second set of capacitive pads.

It will be appreciated that the multiple embodiments and methods discussed herein may be used to individually or to corroborate one another. Additionally, multiple techniques and methods may potentially be used with the same physical apparatus. One or all of these redundant techniques may be used to cross-correlate the collected data. Additionally, while this application relates to the drilling industry for example purposes, the disclosed embodiments may be applied to any industry in which sensing the amount and/or type of flowing media, flowing through a pipe, trough or channel is desired.

What is claimed is:

1. A system for measuring the flow stream height of a liquid flowing through a pipe comprising:
a plurality of capacitive pads, said capacitive pads arranged within a pipe;
a data acquisition system connected to said pads wherein said data acquisition system is capable of measuring the capacitance of each pad; and
a processor capable of calculating the flow stream height based on the capacitance of each pad.

2. The system of claim 1, wherein the capacitive pad geometry is optimized to maximize the signal to noise ratio.

3. The system of claim 1 wherein multiple capacitive pads are axially displaced along the pipe.

4. The system of claim 1 wherein multiple capacitive pads are arranged in at least one array.

5. The system of claim 4 wherein a plurality of arrays are angularly offset from each other.

6. The system of claim 1 wherein the capacitive pads are interdigital finger pads.

7. The system of claim 1 wherein time division multiplexing is used to measure the capacitance of the capacitive pads.

8. The system of claim 1 wherein a dynamic sampling method is used to measure the capacitance of the capacitive pads.

9. The system of claim 8 wherein the capacitance of multiple capacitive pads is measured simultaneously.

10. The system of claim 8 wherein the capacitance of the capacitive pads proximate to a liquid gas interface is measured more frequently than the capacitance of the capacitive pads further from said interface.

11. The system of claim 1 wherein the capacitive pads are arranged on a vertical probe.

12. A method for measuring the flow stream height of a liquid within a pipe comprising:
measuring the capacitance of a plurality of capacitive pads,
calculating the height of a flow stream based on the measured capacitance of the capacitive pads.

13. The method of claim 12 further comprising measuring the capacitance of a plurality of capacitive pads axially displaced from one another.

14. The method of claim 12 further comprising using a previously calculated flow stream height to optimize subsequent measuring of the capacitance from a plurality of capacitive pads.

15. The method of claim 12 wherein the capacitance of multiple capacitive pads is measured simultaneously.

16. The method of claim 12 further comprising calculating the presence of a gas entrained in a liquid stream based on the measured capacitance.

17. A method for measuring the velocity of a liquid flow stream comprising:
using a Doppler radar system to illuminate the surface of a liquid flow stream,
receiving a Doppler radar signal, and
calculating the velocity of the flow stream based on the received Doppler radar signal.

18. The method of claim 17 wherein multiple axially offset sensors are used to measure the velocity of the liquid flow stream.

19. The method of claim 17 further comprising using an ultrasonic flow stream height measurement to calculate the height or velocity of the flow stream

20. A method for calculating the flow stream velocity of a liquid within a pipe comprising:
measuring the capacitance waveforms of a first set of capacitive pads,
measuring the capacitance waveforms of a second set of capacitive pads,
said second set of capacitive pads being axially displaced a known distance from the first set,
comparing the capacitance waveforms of the first set of capacitive pads with the capacitance waveforms of the second set of capacitive pads,
calculating the velocity of the flow stream based on the relationship of the capacitance waveforms of the first set and second set of capacitive pads.
